(19) United States
(12) Patent Application Publication
(10) Pub. No.: US 2007/0206323 A1
(43) Pub. Date: Sep. 6, 2007

(54) Asymmetric type perpendicular magnetic recording head and method of manufacturing the same

(75) Inventors: Young-hun Im, Suwon-si (KR); Hoo-san Lee, Osan-si (KR); Yong-su Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/348,228

(22) Filed: Feb. 7, 2006

(30) Foreign Application Priority Data
Feb. 7, 2005 (KR) 10-2005-0011409

(51) Int. Cl. G11B 5/147

(52) U.S. Cl. 360/126

(57) ABSTRACT

An asymmetric perpendicular magnetic recording head and a method of manufacturing the same, wherein the perpendicular magnetic recording head includes a read head for reading data from a magnetic recording layer and a write head for writing data on the magnetic recording layer. A main pole of the write head has a first surface facing toward the inside of the magnetic recording layer, a second surface opposing a data recording surface of the magnetic recording layer, and a third surface facing toward the outside of the magnetic recording layer and the first surface is asymmetric to the third surface. An angle between one of the first and third surfaces and the second surface may be greater than 90°.

### CROSS-REFERENCE TO RELATED PATENT APPLICATION

This application claims priority from Korean Patent Application Nos. 10-2005-0011409 and 10-2006-0011322, filed on Feb. 7, 2005 and Feb. 6, 2006, respectively, in the Korean Intellectual Property Office, the disclosures of which are incorporated herein in their entirety by reference.

### BACKGROUND OF THE INVENTION

1. Field of the Invention

The present invention relates to a magnetic recording head and a method of manufacturing the sane, and more particularly, to an asymmetric perpendicular magnetic recording head and a method of manufacturing the same.

2. Description of the Related Art

Currently available hard disk drives (HDDs) use a horizontal magnetic recording method as a data recording method. Thus, when data is written to a hard disk, magnetic polarization created at a region of a magnetic recording layer on which data is recorded lies horizontal to the surface of a magnetic recording layer. When data is recorded on the magnetic recording layer using horizontal magnetic recording method, magnetic polarizations may be aligned so that like poles face each other. In this case, the magnetic polarizations that are aligned so that their facing polarities are the same repel each other so a distance between the two magnetic polarizations is larger than a distance between magnetic polarizations that are aligned so that their facing polarities are opposite. An area occupied by magnetic polarizations whose facing polarities are the same is larger than that occupied by the magnetic polarizations whose facing polarities are different, thereby reducing the data recording density of a magnetic recording layer.

An approach to overcoming the problem of the horizontal magnetic recording method is to record data on a magnetic recording layer using a perpendicular magnetic recording method. In the perpendicular magnetic recording method, magnetic polarizations align perpendicular to the surface of the magnetic recording layer. In the perpendicular magnetic recording method, when neighboring magnetic polarizations are aligned in opposite direction, magnetic polarizations tend to move in a direction to decrease an area occupied by themselves, thereby increasing data recording density.

Due to this advantage of perpendicular magnetic recording method, a great deal of attention has been directed toward a perpendicular magnetic recording head actually employing this method and various types of perpendicular magnetic recording heads are currently being introduced.

FIG. 1 is a cross-sectional view of a write head for a conventional perpendicular magnetic recording head, seen from a direction parallel to a track.

Referring to FIG. 1, the write head includes a main pole 10, a return pole 12 and a magnetic inductive coil 14 covered by an insulating layer 16. The magnetic inductive coil 14 and the insulating layer 16 are disposed between the main pole 10 and the return pole 12. A magnetic field Bo for recording bit data on a magnetic recording layer 18 is generated between the main pole 10 and the return pole 12. The magnetic field Bo passes perpendicularly through a predetermined region of the magnetic recording layer 18 immediately below the main pole 10 and a soft under layer (not shown) located under the magnetic recording layer 18 and travels below the soft under layer up to the return pole 12. The magnetic field Bo that arrives at below the return pole 12 then penetrates perpendicularly through the magnetic recording layer 18 into the return pole 12. During this process, upward or downward-directed magnetization occurs in the predetermined region of the magnetic recording layer 18. The magnetization is considered bit data recorded on the predetermined region. An arrow 22 in FIG. 1 indicates the direction in which the magnetic recording layer 18 is moving. FIG. 2 is a front view of the main pole 10 shown in FIG. 1 seen from the right of FIG. 1, i.e., a track direction. Reference numeral 24 in FIG. 2 denotes a track selected from the magnetic recording layer 18.

Referring to FIG. 2, a portion 10a of the main pole 10 located in close proximity to the magnetic recording layer 18 has a width w1 that is less than or equal to a width Tw of a track on the magnetic recording layer 18 and protrudes out of the main pole 10 by a predetermined length. FIG. 3 is a perspective view of the main pole 10 having the projecting portion 10a. Referring to FIG. 3, the portion 10a of the main pole in close proximity to the magnetic recording layer 18 has a uniform width w1 along its entire length and is geometrically symmetric. In FIGS. 2 and 3, reference numerals 24E and 241 respectively denote outward and inward directions of the magnetic recording layer 18.

The conventional perpendicular magnetic recording head having the above-mentioned construction provides increased area density compared to a conventional horizontal magnetic recording head but suffers leakage flux along a track direction as track density and skew angle increase. This may significantly affect an unselected track during data recording on a selected track.

### SUMMARY OF THE INVENTION

The present invention provides a perpendicular magnetic recording head with a magnetic recording layer with high track density and which can reduce the amount of leakage flux.

The present invention also provides a method of manufacturing the perpendicular magnetic recording head.

According to an aspect of the present invention, there is provided a perpendicular magnetic recording head including a read head reading data from a magnetic recording layer and a write head writing data on the magnetic recording layer, wherein the write head is a single pole head including a main pole and a return pole. The main pole has a first surface facing the inside of a track of the magnetic recording layer, a second surface facing a data recording surface of the magnetic recording layer, and a third surface facing the outside of the track of the magnetic recording layer, wherein the first surface is asymmetric to the third surface.

An angle between one of the first and third surfaces and the second surface may be greater than 90°. Alternatively, the first and third surfaces may be symmetric to each other and form an angle of greater than 90° with the second surface.

The perpendicular magnetic recording head may further comprise a sub yoke on a side of the main pole facing the read head. In this case, the perpendicular magnetic recording head may further comprise a shield layer between the sub yoke and the read head.

According to another aspect of the present invention, there is provided a method of manufacturing a perpendicular magnetic recording head, the method including: forming a read head on a substrate; forming a magnetic shield layer on the read head; forming a main pole magnetic layer on the magnetic shield layer; patterning the main pole magnetic layer such that a first surface of the main pole magnetic layer facing the inside of a track of a magnetic recording layer is asymmetric to a third surface of the main pole magnetic layer facing the outside of the track of the magnetic recording layer; forming an insulating layer including a magnetic inductive coil on the asymmetrically patterned main pole magnetic layer; removing a portion of the insulating layer to expose a portion of the main pole magnetic layer; and forming a return pole magnetic layer on the insulating layer to contact the exposed portion of the main pole magnetic layer.

In the patterning of the main pole magnetic layer, one of the first and third surfaces is obliquely formed such that the one surface forms an angle of greater than 90° with a second surface of the portion in close proximity to the magnetic recording layer opposing a data recording surface of the magnetic recording layer.

The patterning of the main pole magnetic layer may further include: forming a photoresist layer on the main pole magnetic layer to expose a region of the main pole magnetic layer; and patterning the photoresist layer such that a portion of the exposed region of the main pole magnetic layer that will be in close proximity to the magnetic recording layer is asymmetrically formed.

In the method, two opposing insides of a portion of the photoresist layer that defines a portion of the exposed region of the main pole magnetic layer that will be in close proximity to the magnetic recording layer may not be parallel to each other.

The method may further include forming a sub yoke between the magnetic shield layer and the main pole magnetic layer to contact the main pole magnetic layer. In this case, the method may further include forming an additional shield layer between the sub yoke and the magnetic shield layer.

The perpendicular magnetic recording head provides an increased track density (TPI) as well as data recording density. The gradient of a magnetic field generated by the main pole increases due to the asymmetric structure, thereby reducing an effect of the head on a track adjacent to the selected track during the recording of data on the selected track. The present invention can also significantly increase the track density with a simple manufacturing process including a cutting step in addition to a conventional process.

### BRIEF DESCRIPTION OF THE DRAWINGS

The above and other aspects of the present invention will become more apparent by describing in detail exemplary embodiments thereof with reference to the attached drawings in which:

FIG. 1 is a cross-sectional view of a write head for a conventional perpendicular magnetic recording head, seen from a direction parallel to a track;

FIG. 2 is a front view of the main pole shown in FIG. 1 seen from the direction in which the head of FIG. 1 is moving;

FIG. 3 is a perspective view of the main pole shown in FIG. 1 having a portion in close proximity to the magnetic recording layer;

FIG. 4 is a cross-sectional view of an asymmetric perpendicular magnetic recording head, seen from a direction parallel to a track, according to a first exemplary embodiment of the present invention;

FIG. 5 is front view of the main pole shown in FIG. 4 seen from the direction in which the head of FIG. 1 is moving;

FIG. 6 is a perspective view illustrating a characteristic portion of the main pole shown in FIG. 4;

FIG. 7 is graphs of a magnetic field gradient in a recording direction at a magnetic recording layer when data is recorded using a conventional perpendicular magnetic recording head and a perpendicular magnetic recording head according to the present invention;

FIG. 8 is graphs of a magnetic field gradient in a track direction at a magnetic recording layer when data is recorded using a conventional perpendicular magnetic recording head and a perpendicular magnetic recording head according to the present invention;

FIG. 9 is a graph showing the intensity distribution of magnetic field in a track direction within a magnetic recording layer when data is recorded using a conventional symmetric type perpendicular magnetic recording head and an asymmetric perpendicular magnetic recording head according to the present invention;

FIGS. 10 and 11 respectively show the results of simulations of intensity distributions of magnetic field when data is recorded using a conventional symmetric type perpendicular magnetic recording head and an asymmetric perpendicular magnetic recording head according to the present invention;

FIGS. 12 through 17 are cross-sectional views and plan views illustrating a method of manufacturing an asymmetric perpendicular magnetic recording head according to an exemplary embodiment of the present invention;

FIG. 18 is a cross-sectional view of an asymmetric perpendicular magnetic recording head, seen from a direction parallel to a track, according to a second exemplary embodiment of the present invention;

FIG. 19 is a cross-sectional view of an asymmetric perpendicular magnetic recording head, seen from a direction parallel to a track, according to a third exemplary embodiment of the present invention;

FIGS. 20 through 23 are sectional views for explaining each operation of a method of manufacturing the asymmetric perpendicular magnetic recording head of FIG. 18; and

FIG. 24 is a front view illustrating the geometrical shape of a main pole of the asymmetric perpendicular magnetic recording head.

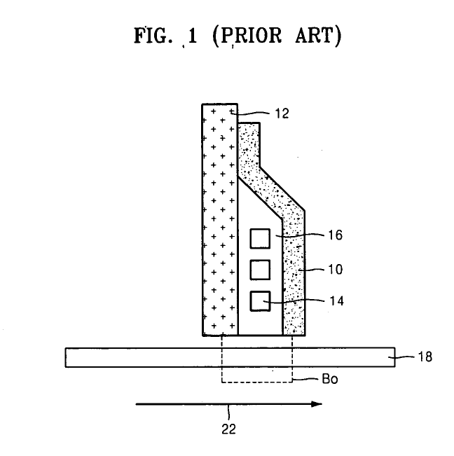

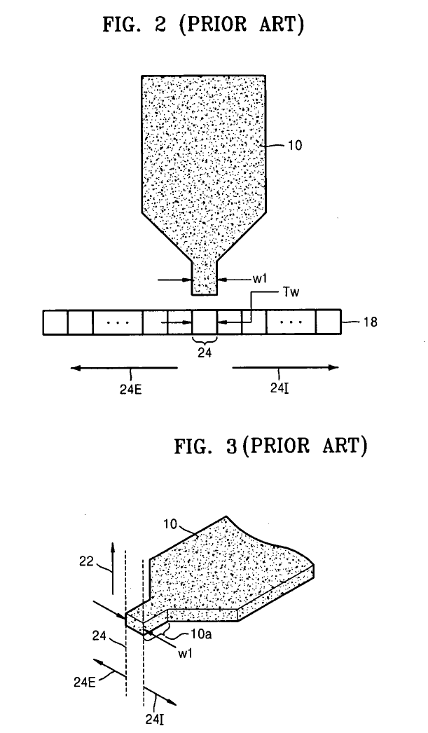

### DETAILED DESCRIPTION OF EXEMPLARY EMBODIMENTS OF THE INVENTION

Hereinafter, an asymmetric magnetic recording head and a method of manufacturing the same according to exemplary embodiments of the present invention will be described more fully with reference to the accompanying drawings. In the drawings, the thicknesses of layers and regions are not to scale but instead may be exaggerated for clarity.

First, an asymmetric perpendicular magnetic recording head (hereinafter referred to as a magnetic head) according to an exemplary embodiment of the present invention will be described.

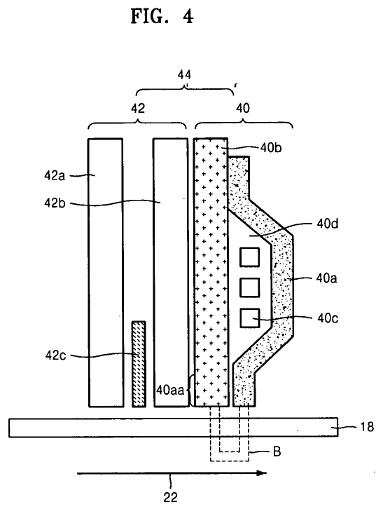

Referring to FIG. 4, the magnetic head 44 includes a write head 40 and a read head 42. The write head 40 is disposed in front of the read head 42 based on a direction 22 in which the magnetic recording layer 18 is moving. The write head 40 includes a main pole 40b contacting the read head 42 and a return pole 40a around which a magnetic inductive coil 40c is wrapped. The return pole 40a has one end coupled to the main pole 40b and the other end located in close proximity to a magnetic recording layer 18. A middle portion of the return pole 40a is convexly protruded and an insulating layer 40d is formed between the return pole 40a and the main pole 40b. The other end of the return pole 40a is spaced apart from the main pole 40b by a given gap that has a very small width and is filled with the insulating layer 40d. The magnetic inductive coil 40c is buried in the insulating layer 40d.

A dotted line B connecting the main pole 40b with the return pole 40a denotes a magnetic field induced between the main pole 40b and the return pole 40a during the recording of bit data. The read head 42 includes first and second magnetic shield layers 42a and 42b and a reading device 42c disposed between the first and second magnetic shield layers 42a and 42b. When data is read from a given position on a selected track, the first and second magnetic shield layers 42a and 42b prevent a magnetic field generated by a magnetic element surrounding the given position from extending into the given position. The reading device 42c may be a giant magnetoresistive (GMR) or a tunneling magnetoresistive (TMR). The main feature of the magnetic head 44 lies in a portion 40aa of the main pole 40b which is in close proximity to the magnetic recording layer 18.

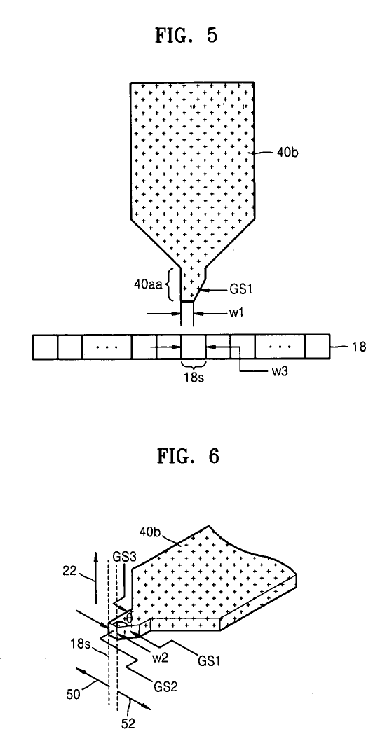

FIG. 5 is front view of the main pole 40b shown in FIG. 4 seen from the right of FIG. 4. Referring to FIG. 5, the portion 40aa of the main pole 40b in close proximity to the magnetic recording layer 18 has an uneven width. That is, the width of the main pole 40b decreases towards the magnetic recording layer 18. A lower width w2 of the portion 40aa is less than a width w3 of a track 18s of the magnetic recording layer 18. Based on the foregoing, the portion 40aa of the main pole 40b in close proximity to the magnetic recording layer 18 has a width that progressively decreases towards the magnetic recording layer 18 because a surface (GS1) of the main pole 40b positioned along a direction perpendicular to the track 18s or a direction in which a support arm (not shown) supporting the magnetic head of the present invention rotates is obliquely cut.

FIG. 6 is a perspective view of the main pole 40b containing the portion 40aa. In FIG. 6, first and second arrows 50 and 52 respectively denote outward and inward radial directions of the magnetic recording layer 18. An angle θ between first and second surfaces GS1 and GS2 of the portion of main pole 40b in close proximity to the magnetic recording layer 18 is greater than 90°. The first surface GS1 faces toward the inside of a track of the magnetic recording layer 18 and the second surface GS2 opposes the track 18s. While FIG. 6 shows that a third surface GS3 of the portion 40aa of the main pole 40b facing toward the outside of the track of the magnetic recording layer 18 forms an angle of 90° with the second surface GS2 opposing the track 18s, the angle between the second and third surfaces GS2 and GS3 may be greater than 90° and the angle between the first and second surfaces GS1 and GS2 may be 90°. That is, a portion of the main pole 40b facing toward the outside of the magnetic recording layer 18 is asymmetric to a portion of the main pole 40 facing the inside of the magnetic recording layer 18. On the other hand, both the angle θ between the first and second surfaces GS1 and GS2 and the angle between the second and third surfaces GS2 and GS3 may be greater than 90°. At this time, the two angles may be different. Accordingly, the main pole 40b may become asymmetric.

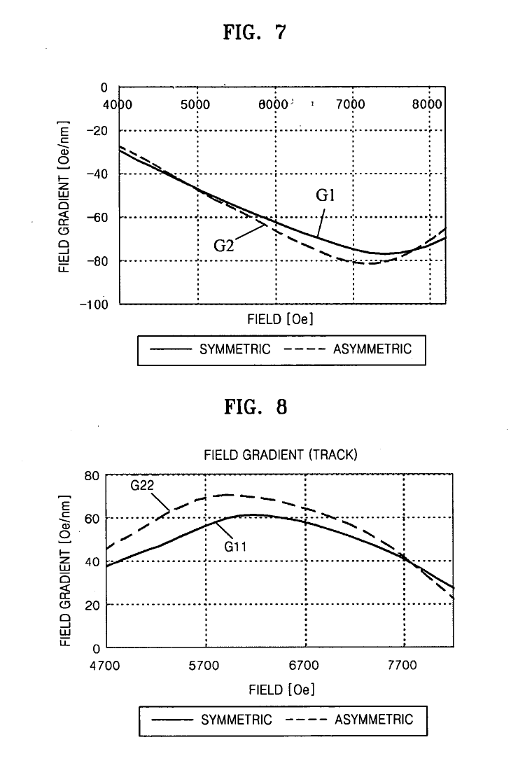

FIG. 7 is a graph illustrating curves G1 and G2 of a magnetic field gradient in a recording direction at a magnetic recording layer when the main pole 40b is symmetric as in a conventional magnetic head (“first case”) and when the return pole 40a is asymmetric as in the magnetic head of the present invention (“second case”), respectively.

FIG. 8 is a graph illustrating curves G11 and G22 of a magnetic field gradient in a track direction at a magnetic recording layer for the first and second cases.

Referring to FIG. 7, a field gradient in the curve G2 is greater than that in the curve G1. The large field gradient means that dispersion of the magnetic field is small. As is evident from FIG. 7, in the recording direction, a concentration degree of the magnetic field of the magnetic head of the present invention is higher than that of the conventional magnetic head. Thus, the magnetic head of the present invention achieves an increased linear recording density in the recording direction.

Referring to FIG. 8, like in FIG. 7, a field gradient in the curve G22 is greater than that in the curve G11, which means the dispersion of the magnetic field in the track direction is smaller in the first case than that in the second case. Thus, the magnetic head of the present invention provides increased tracking density while reducing an effect of the magnetic field on an unselected track during data recording.

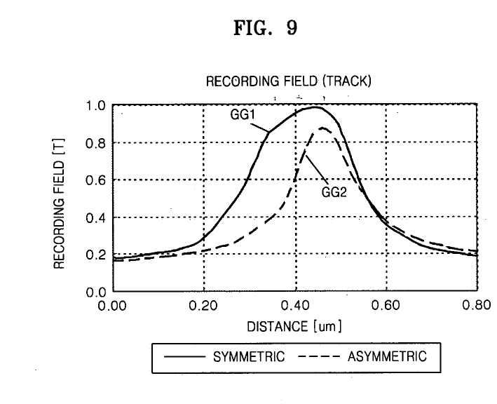

FIG. 9 is a graph illustrating curves GG1 and GG2 of a change in magnetic field in a track direction within a magnetic recording layer when data is recorded using a conventional magnetic head (“first case”) and a magnetic head of the present invention (“second case”), respectively. Referring to FIG. 9, the curve GG1 exhibits a higher degree of magnetic field dispersion in a vertical direction than the curve GG2, which means that the concentration of the magnetic field is significantly higher for the second case than for the first case. Thus, the result shown in FIG. 9 is obtained by combining the results shown in FIGS. 7 and 8.

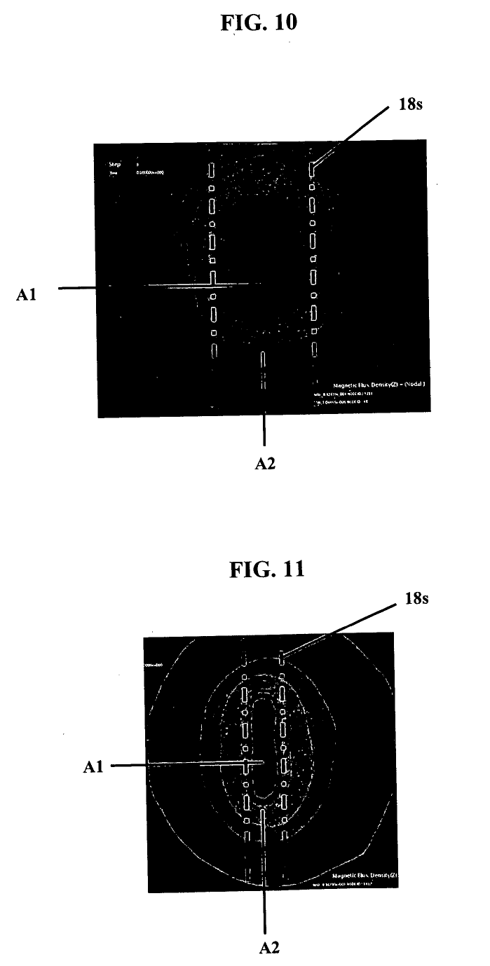

The result can be further clarified by comparing simulation results shown in FIGS. 10 and 11.

FIGS. 10 and 11 respectively show the results of simulations of intensity distributions of magnetic field for the first and second cases. First and second regions A1 and A2 respectively denote regions exhibiting the highest and next-highest magnetic field intensities. Referring to FIG. 10, the first region A1 is located within a track 18s but the second region A2 is located slightly outside the track 18s. On the other hand, referring to FIG. 11, both the first and second regions A1 and A2 are located within the track 18s. The result of this comparison demonstrates that the second case (FIG. 11) exhibits a significantly higher degree of concentration of magnetic field than the first case (FIG. 10). The result also shows that the effect of magnetic field on an adjacent track is much less in the second case than in the first case.

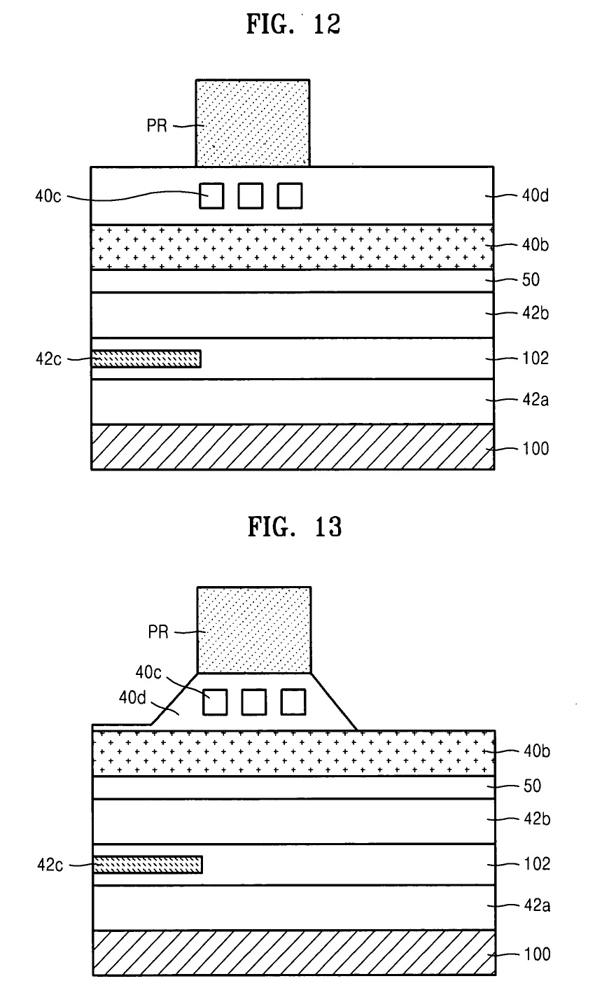

FIGS. 12 through 17 illustrate a method of manufacturing a magnetic head according to an exemplary embodiment of the present invention.

Referring to FIG. 12, a first magnetic shield layer 42a and an interlayer dielectric layer 102 are sequentially formed on a substrate 100. A reading device 42c is formed within the interlayer dielectric layer 102 during the formation of the interlayer dielectric layer 102. Subsequently, the second magnetic shield layer 42b is formed on the interlayer dielectric layer 102. An interlayer dielectric layer 50 is formed on the second magnetic shield layer 42b. A main pole 40b and an insulating layer 40d are sequentially stacked on the interlayer dielectric layer 50. A magnetic inductive coil 40c is buried in the insulating layer 40d during the formation of the insulating layer 40d. A photoresist layer PR is formed on the insulating layer 40d to cover the magnetic inductive coils 40c. The insulating layer 40d is etched using the photoresist layer PR as an etch mask until the main pole 40b is exposed. FIG. 13 shows the resulting structure obtained by the etching.

Referring to FIG. 13, a portion of the insulating layer 40d opposing a magnetic recording layer 18, which is located to the left side of the photoresist layer PR, is not completely removed but remains. A portion of the insulating layer 40d located on the right side of the photoresist layer PR is completely removed until the main pole 40b is exposed.

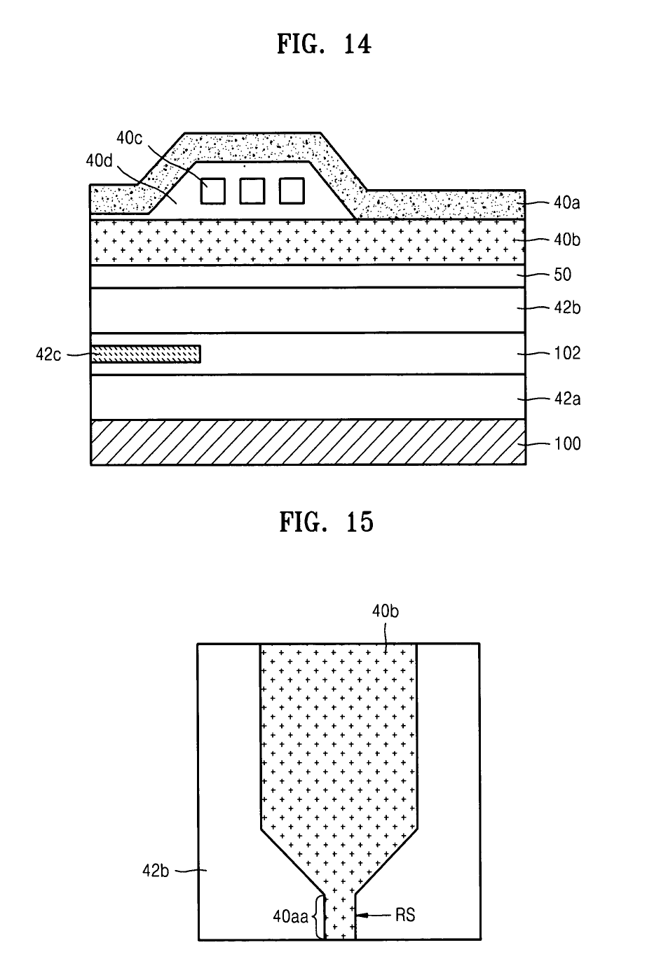

After the etching, a stepped portion having the thickness of the insulating layer 40d is formed between the top surface of the insulating layer 40d covered by the photoresist layer PR and a portion of the main pole 40b exposed by the etching. Due to the characteristics of dry etching, the side of the insulating layer 40d extending from the top surface of the insulating layer 40d to the exposed portion of the main pole 40b is oblique. Referring to FIG. 14, the photoresist layer PR is removed after the etching and then a return pole 40a is formed on the insulating layer 40d. The return pole 40a contacts a portion of the main pole 40b exposed by the etching.

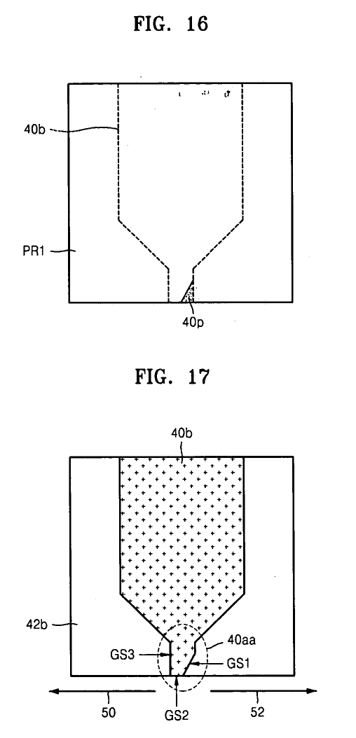

FIG. 15 is a plan view of the main pole 40b. Referring to FIG. 15, a portion 40aa of the main pole 40b close to the magnetic recording layer 18 has a width that is less than the other portion of the main pole 40b. Alternatively, the main pole 40b may have a width that progressively increases upward from the narrow portion 40aa up to a specific point and a uniform width from the specific point to the top. After the main pole 40b is formed as shown in FIG. 15, referring to FIG. 16, a photoresist layer PR1 is formed on the resulting structure in which the main pole 40b has been formed. The photoresist layer PR1 exposes the right side of the narrow portion 40aa of the main pole 40b in the form of a right-angled triangle.

An exposed portion 40p of the main pole 40b is etched using the photoresist layer PR1 as an etch mask until the interlayer dielectric layer 50 is exposed. After the etching, the photoresist layer PR1 is removed. FIG. 17 shows the resulting structure from which the photoresist layer PR1 has been removed.

Referring to FIG. 17, after the etching, the lower right side of the narrow portion 40aa of the main pole 40b facing toward an inside 52 of the magnetic recording layer becomes an oblique first surface GS1. Thus, an angle between the first surface GS1 and a second surface GS2 opposing the magnetic recording layer is greater than 90°. The lower width of the narrow portion 40aa of the main pole 40b decreases towards the magnetic recording layer. The lower width (w2 in FIG. 5) of the narrow portion 40aa of the main pole 40b may be less than a width of a track of the magnetic recording layer.

When a lower left side of the narrow portion 40aa of the main pole 40b is defined as the exposed portion 40p during the formation of the photoresist layer PR1 as shown in FIG. 16, a third surface GS3 is oblique as shown in FIG. 17. Alternatively, when both the lower left and right sides of the narrow portion 40aa are exposed during the formation of the photoresist layer PR1, the first and third surfaces GS1 and GS3 are obliquely formed as shown in FIG. 17.

Hereinafter, a perpendicular magnetic recording head according to a second exemplary embodiment of the present invention will be described.

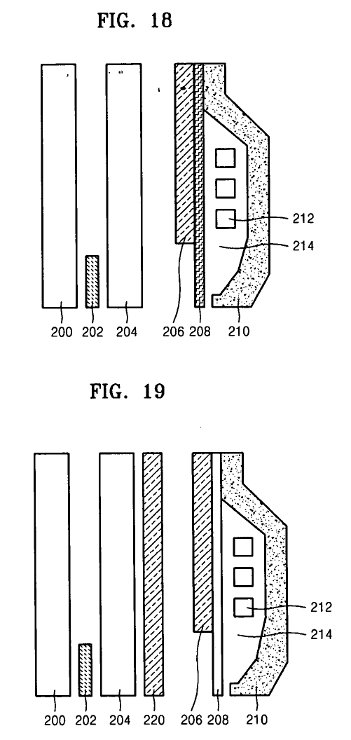

Referring to FIG. 18, a recording device 202 is located between a first shield layer 200 and a second shield layer 204. A sub yoke 206 focusing a magnetic field on the main pole 208 is separated from the second shield layer 204. The sub yoke 206 is arranged in a state facing and parallel with the second shield layer 204. The main pole 208 contacts a right side of the sub yoke 206. A lower end of the sub yoke 206 is located above a lower end of the main pole 208. The return pole 201 is on the right side of the main pole 208. An upper side of the return pole 210 contacts an upper side of the main pole 208, while a lower side of the return pole 210 is separated by a small distance from the lower side of the main pole 210. The geometrical shape of the main pole 208 is the same as the geometrical shape of the main pole 40b according to the first exemplary embodiment illustrated in FIG. 4. An insulating layer 214 is disposed between the main pole 208 and the return pole 210. A magnetic inductive coil 212 is disposed in the insulating layer 214. The insulating layer 214 may be, for example, an Al₂O₃ layer. As described above, the structures of the main pole 208 and the return pole 210 are almost the same as in the first exemplary embodiment illustrated in FIG. 4.

Although not illustrated, the spaces between constituent elements in FIG. 18 are filled with an insulating layer, for example, an Al₂O₃ layer.

Hereinafter, a perpendicular magnetic recording head according to a third exemplary embodiment of the present invention will be described. In the present exemplary embodiment, descriptions of the perpendicular magnetic recording head will be focused on portions which differ from the perpendicular magnetic recording head of FIG. 18.

Referring to FIG. 19, a third shield layer 220 is further formed between the second shield layer 204 and the sub yoke 206, and the third shield layer 220 does not contact the second shield layer 204 and the sub yoke 204, which are the differences from the perpendicular magnetic recording medium of FIG. 18.

Hereinafter, a method of manufacturing the perpendicular magnetic recording head of FIG. 18 will be described. Since the structure of the perpendicular magnetic recording head of FIG. 19 does not greatly differ from the structure of the perpendicular magnetic recording head of FIG. 18, this method can be used to manufacture the perpendicular magnetic recording head of FIG. 19

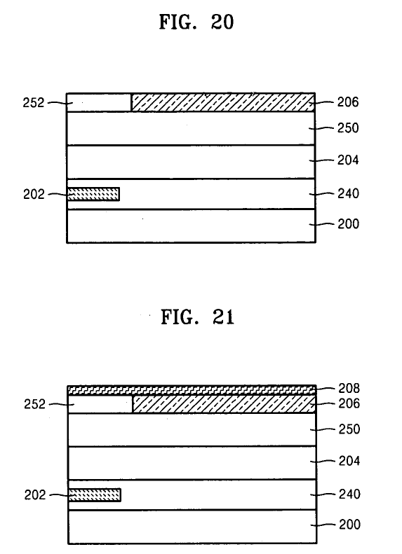

Referring to FIG. 20, a first shield layer 20 and an insulating layer 240 are sequentially formed on the substrate 100. The reading device 202 is formed in the insulating layer 240 during the formation of the insulating layer 240. The reading device 202 can be the same as in the first exemplary embodiment of FIG. 4. The reading device 202 is disposed in the insulating layer 240 such that only one side thereof is exposed. The second shield layer 204 is formed on the insulating layer 240. Subsequently, a first interlayer dielectric layer 250 is formed on the second shield layer 204. The first interlayer dielectric layer 250 can be formed of, for example, an aluminium oxide layer. A second interlayer dielectric layer 252 is formed on a region of the first interlayer insulating layer 250 to a predetermined thickness. The sub yoke 206 is formed on the remaining region of the first interlayer insulating layer 250 to the same thickness as the second interlayer insulating layer 252. The sub yoke 206 can be formed using a predetermined process, for example, a lift-off process. After the sub yoke 206 has been formed, upper surfaces of the second interlayer insulating layer 252 and the sub yoke 206 are planarized using chemical mechanical polishing (CMP).

Subsequently, referring to FIG. 21, the upper surfaces of the second interlayer insulating layer 252 and the sub yoke 206 planarized using the CMP method are covered with the main pole 208 having a predetermined thickness. Next, the main pole 208 is processed using photolithography into a shape as illustrated in FIG. 24. This process is the same as described with reference to FIG. 4.

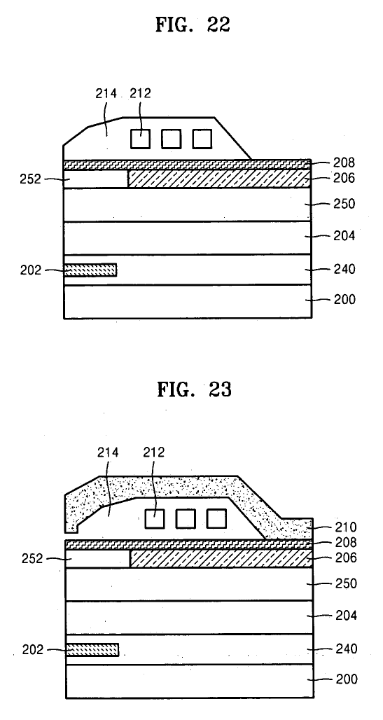

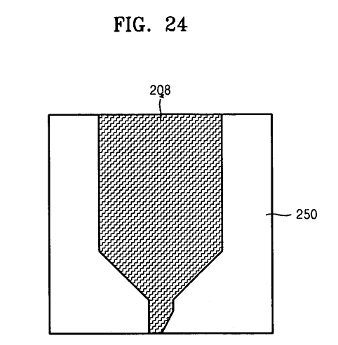

Next, referring to FIG. 22, the insulating layer 214 in which the magnetic inductive coil 212 is buried is formed on a region of the main pole 208. The insulating layer 214 can be formed of, for example, an aluminium oxide layer. The left and right sides of the insulating layer 214 are obliquely formed. The return pole 210 is formed on the insulating layer 214 as illustrated in FIG. 23. A first side of the return pole 210 contacts the exposed portion of the main pole 208 on which the insulating layer 214 is not formed. A second side of the return pole 210 is separated by a small distance from the main pole 208 due to the insulating layer 214. A portion of the return pole 210 between the first and second sides has a convex shape due to the insulating layer 214.

In a method of manufacturing the perpendicular magnetic recording head of FIG. 19, the third shield layer 220 may be further formed on the first interlayer insulating layer 250. At this time, the second interlayer insulating layer 252 and the sub yoke 206 are formed on the third interlayer insulating layer 220. Here, the third shield layer 220 does not contact the sub yoke 206.

The invention should not be construed as being limited to the exemplary embodiments set forth herein; rather, these exemplary embodiments are provided so that this disclosure will be thorough and complete. For example, it will be understood by those of ordinary skill in the art that the main pole 40b can have a different geometric shape while maintaining the feature of the lower narrow portion 40aa of the main pole 40b. Furthermore, a modification may be made to other elements than the main pole 40b. The main pole 40b may be formed using a lift-off process. That is, the photoresist layer PR is formed on the insulating layer 40d and defines and exposes a region of the insulating layer 40d in the same form as the final shape of the main pole 40b. A magnetic layer is formed on the exposed portion of the insulating layer 40d and the photoresist layer PR is removed, thereby obtaining an asymmetric main pole. As described above, various changes in form and details may be made therein without departing from the spirit and scope of the present invention as defined by the following claims.

As described above, in a perpendicular magnetic recording head of the present invention, a first surface (or a third surface facing outward the track) of a lower portion of main pole in close proximity to a magnetic recording layer, which faces inward a track, is obliquely cut. Because an angle between a second surface of the lower portion opposing the track of the magnetic recording layer and the first surface is greater than 90° while an angle between the second and third surfaces is 90°, the main pole has an asymmetric structure. Since a width of the second surface can be adjusted according to the cutting slope of the first surface, a width of a write head in a track direction can be made less than the width of the track of the magnetic recording layer, thereby increasing a track density (tracks per inch (TPI)). The gradient of a magnetic field generated by the main pole increases due to the asymmetric structure, thereby reducing the amount of leakage flux as well as an effect of the head on a track adjacent to the selected track. The present invention can also significantly increase the track density with a simple manufacturing process including a cutting step in addition to a conventional process.

What is claimed is:

1. A perpendicular magnetic recording head comprising:
a read head which reads data from a magnetic recording layer; and
a write head which writes data on the magnetic recording layer,
wherein the write head is a single pole head comprising a main pole and a return pole, and
wherein the main pole has a first surface facing the inside of a track of the magnetic recording layer, a second surface extending from the first surface and opposing a data recording surface of the magnetic recording layer, and a third surface extending from the second surface and facing the outside of the track of the magnetic recording layer, and the first surface is asymmetric to the third surface.

2. The perpendicular magnetic recording head of claim 1, wherein an angle between the second surface and one of the first and third surfaces is greater than 90°.

3. The perpendicular magnetic recording head of claim 1, wherein a width of lower portion of the main pole, which has the first, second and third surfaces, is tapered.

4. The perpendicular magnetic recording head of claim 1, further comprising a sub yoke on a side of the main pole facing the read head.

5. The perpendicular magnetic recording head of claim 4, further comprising a shield layer between the sub yoke and the read head.

6. A perpendicular magnetic recording head comprising:
a read head which reads data from a magnetic recording layer; and
a write head which writes data on the magnetic recording layer,
wherein the write head is a single pole head comprising a main pole and a return pole, and
wherein the main pole has a first surface facing the inside of a track of a magnetic recording layer, a second surface extending from the first surface and opposing a data recording surface of the magnetic recording layer, and a third surface extending from the second facing the outside of the track of the magnetic recording layer, wherein the first and third surfaces are symmetric to each other and form an angle of greater than 90° with the second surface.

7. The perpendicular magnetic recording head of claim 6, further comprising a sub yoke on a side of the main pole facing the read head.

8. The perpendicular magnetic recording head of claim 7, further comprising a shield layer between the sub yoke and the read head.

9. A method of manufacturing a perpendicular magnetic recording head, the method comprising:
forming a read head on a substrate;
forming a magnetic shield layer on the read head;
forming an interlayer dielectric layer on the magnetic shield layer;
forming a main pole magnetic layer on the interlayer dielectric layer;
patterning the main pole magnetic layer such that a first surface of the main pole magnetic layer facing toward the inside of a track of a magnetic recording layer is asymmetric to a third surface of the main pole magnetic layer facing the outside of the track of the magnetic recording layer;
forming an insulating layer including a magnetic conductive coil on the patterned main pole magnetic layer;
removing a portion of the insulating layer to expose a portion of the main pole magnetic layer; and
forming a return pole magnetic layer on the insulating layer to contact the portion of the main pole magnetic layer which is exposed.

10. The method of claim 9, wherein, in the patterning of the magnetic layer, one of the first and third surfaces is obliquely formed such that the one of the first and third surfaces forms an angle of greater than 90° with a second surface of the portion opposing a data recording surface of the magnetic recording layer.

11. The method of claim 9, wherein the patterning of the main pole magnetic layer further comprises:
forming a photoresist layer on the main pole magnetic layer to expose a region of the main pole magnetic layer close to the magnetic recording medium; and
patterning the photoresist layer such that a portion of the region of the main pole magnetic layer which is exposed is asymmetrically formed.

12. The method of claim 11, wherein two opposing inner portions of the photoresist layer that defines a portion of the exposed region of the main pole magnetic layer are not parallel to each other.

13. The method of claim 9, further comprising forming a sub yoke between the magnetic shield layer and the main pole magnetic layer to contact the main pole magnetic layer.

14. The method of claim 13, further comprising forming an additional shield layer between the sub yoke and the magnetic shield layer.
